(19) United States
(12) Patent Application Publication
(10) Pub. No.: US 2007/0176739 A1
(43) Pub. Date: Aug. 2, 2007

(54) Multifunction keyless and cardless method and system of securely operating and managing housing facilities with electronic door locks

(75) Inventor: Syed F. Raheman, Nagpur (IN)

Correspondence Address: Syed F. Raheman, 101 Greenway Drive, Farmingdale, NY, 11735, US

(73) Assignee: FoneKey, Inc., Farmingdale, NY (US)

(21) Appl. No.: 11/507,557

(22) Filed: Aug. 22, 2006

Related U.S. Application Data
(60) Provisional application No. 60/759,725, filed on Jan. 19, 2006.

(51) Int. Cl. G05B 19/00

(52) U.S. Cl. 340/5.64; 340/5.28; 713/176; 455/556.1

(57) ABSTRACT

An improved electronic lock with keyless, cardless digital key system and integrated facilities management and administration system is provided for use in multi-unit buildings, particularly in hospitality industry. The present invention relates generally to a network architecture that integrates a wireless communication network device operating a plurality of electronic locks, and the all-inclusive property administration and management system in a multi-unit facility such as a hotel or a condominium.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Locks are omnipresent. All residences, businesses, hotels, governmental offices, vehicles and storage spaces, cabinets and safes utilize locks. These locks control physical access to premises or spaces. Although locks are most commonly employed on doors, they may also control access to windows, lockers, storage cabinets, safes etc. Locks have long been traditionally operated using a mechanical key. However, electronic locks have become more prevalent. The electronic locks are electrically activated to a locked or an unlocked condition using a myriad of key technologies. Such key technologies include a magnetic swipe card, embedded microelectronic devices, radio frequency or infrared transmitters, or electronic keypad combinations or even telecommunication network.

There is large amount of prior art in electronic locks per se. The integration of electronic locks with computer network is described by a few of pending patent applications. U.S. application Publication No. 2002/0099945 (Jul. 25, 2002), for example, describes a door access control system. One or more electronic door locks communicate with a computerized administration system. When a user wishes to gain access to an electronic lock, the electronic lock first identifies the user. The electronic lock then communicates with the computerized administration system to authorize the user. If the user is authenticated, a computer activates the electronic door lock.

U.S. application Publication No. 2002/0095960 (Jul. 25, 2002) describes a storage locker with an electronic lock. The electronic lock has a communication port for connection to a telephone line. The communication port allows the electronic lock to be monitored and controlled from a computer at a remote location. U.S. application Publication No. 2001/0041956 (Nov. 15, 2001) describes a vehicle door lock system. A person wishing to access the vehicle may use a mobile telephone to unlock (or lock) the vehicle doors. A communication controller receives the cellular telephone communication and instructs a microcontroller to activate the door locks. U.S. application Publication No. 2004/0165708 (Aug. 26, 2004) describes a lock service that allows a user to remotely activate an electronic lock using the telecommunications network. U.S. application Publication No. 2003/0149576 (Aug. 7, 2003) describes an automatic hotel room check-in and pre-conditioning of hotel rooms by using a smart card for remote check in.

U.S. application Publication No. 2003/0107468 (Jun. 12, 2003) describes a contactless keycard and the validation device that operate by constantly generating dynamic identification codes. International patent application WO 93/14571 discloses a secure entry system utilizing a cellular telephone as an electronic key device transmitting RF signals to a lock, allowing a user to operate the buttons on the telephone as buttons on a keypad to gain access to the secured area.

The need for guest convenience and control, constantly changing keys, multiple levels of access, administration of large number of rooms, security and privacy of hotel guests, efficient housekeeping, automatic catering to guest preferences and efficiency of hotel personnel make hospitality industry a prime target for advancement of the electronic lock systems of the prior art. None of is the disclosures in the prior art satisfy the unmet needs of further improvising the guest services and housekeeping efficiency of the hospitality industry. In co-pending applications this inventor has described a highly secure dynamic method of online authentication using mobile phones. The instant invention is an extension of the network security of a virtual online transaction of his co-pending inventions to a physical environment of securing brick and mortar building premises.

The locks are programmed to allow particular individual's access to particular rooms using digital codes either encrypted on a card key or entered via a digital keypad interface. Difficulties may arise when one resident of a room replaces another, as the new resident must be provided with a key distinct from the previous resident such that the previous resident no longer has access to the room. Difficulties in integration of billing, housekeeping, energy management and other guest services extended to the room occupants during their stay render the network of electronic locks in a building less efficient. Security issues may also arise when the housekeeping personnel need the room access. Typically, the electronic lock operates by recognizing the more recently created key such that any previous key no longer unlocks the electronic lock. In some cases, particularly in hospitality industry, when duplicate keys are programmed to access the same room, the other previously programmed key is disabled, while the housekeeping or the management key remains valid. Different people accessing the room may require different access rights, for example the guest requiring unlimited access from the point he checks in to the time he checks out. The housekeeping staff requires access only for the purpose of cleaning or servicing the room, while the higher management may require unlimited administrative access at all times. These circumstances are particularly very common in hospitality industry.

The instant invention improvises the operation of electronic locks and fully integrates the local network of electronic locks with a wireless device network. Thus bestowing a high level of convenience and control in the hands of the guests on one hand, and seamless integration of management and administration of the facility for the facility owner on the other. The invention not only results in high customer satisfaction for the guests but significant cost savings for the building management. Accordingly, there is a need for a system described herein to overcome the limitations of the prior art.

### BRIEF SUMMARY OF THE INVENTION

The hospitality industry constantly strives to improve the amenities and facilities extended to their guests. It was hospitality industry that first adopted the electronic locks, which were operated by credit card sized card keys and not the conventional metal keys. The guest room access has since been improvised by the use of chip-based smart cards and by online access to many of the guest services. The management of the facilities and housekeeping has also been computerized to enhance efficiency. However, the full integration of the card key access with the rest of the facility management and administration interface is not possible on account of limitation of the card key to interact with the rest of the network in real time.

It would be an improvement to provide a new method of access control and management of areas or premises secured by electronic locks, using a new keyless and cardless approach to the problem of access code synchronization between the locks, keys and overall facility administration. Consequently, it is an advantage of the invention that a plurality of different access codes to different lock secured premises in different facilities may be generated and assigned to one or more wireless key devices, providing a flexible way of customizing an access right profile for each wireless key device and the corresponding premises.

It is therefore an object of the present invention to provide a user friendly, cost-saving, value adding electronic lock and contactless digital key technology that overcomes the problems residing in the prior art. It is another object of the invention to provide a keyless and cardless access that replaces conventional electronic card keys, in which the access code disclosure device is a wireless device such as a mobile phone.

It is yet another object of the present invention to provide a wireless device resident digital key operating a plurality of electronic locks in a network via a local communicator server, and a master administrator server, which has an improved convenience and portability for the user and efficient cost saving administration for the facility management. It is still another object of the invention to provide a secure access code that is randomly generated in real time by the electronic lock apparatus.

It is yet another object of the instant invention to integrate the electronic lock and key mechanism with the software applications that manage all aspects of the facility maintenance and administration including reservation, access, check in and check out, billing and payment, guest preferences, housekeeping, guestroom paraphernalia and energy management.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results or modifying the invention as will be described. Accordingly, referring to the following drawings may have a complete understanding of the invention. Description of the preferred embodiment is as follows.

### BRIEF DESCRIPTION OF THE SEVERAL VIEWS OF THE DRAWINGS

FIG. 1 is a block diagram illustrating the network architecture of a preferred embodiment implemented through five nodes and seven modules.

FIG. 2 illustrates a schematic representation of the software modules of a preferred embodiment implemented through four different interfaces.

### DETAILED DESCRIPTION OF THE INVENTION

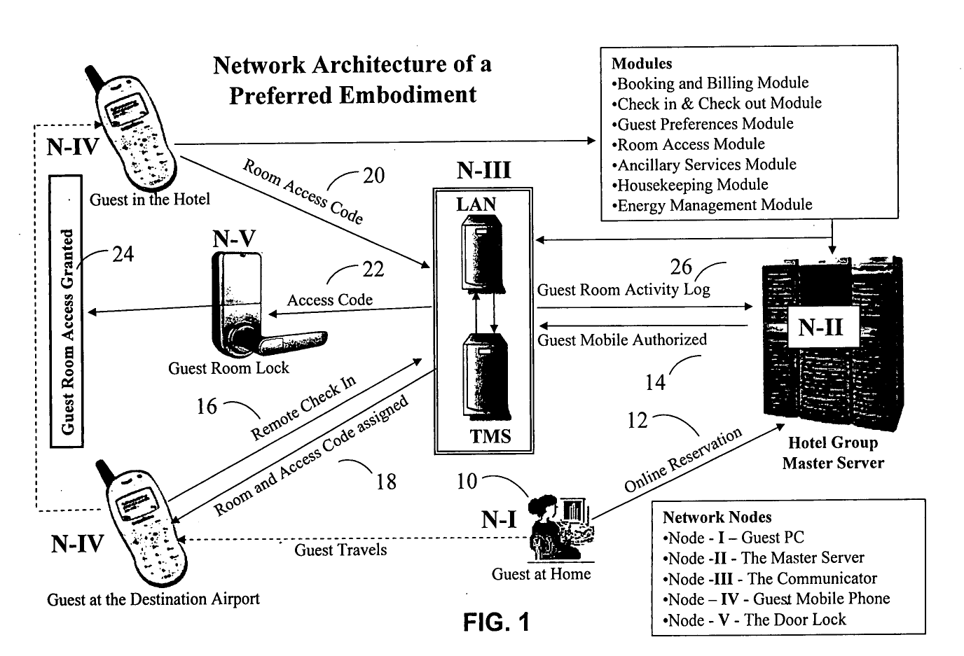

The novel features of the instant invention can be deployed in any multi-unit building facility. However the preferred embodiment of the invention is described, as it would be implemented in administration and management of a hospitality infrastructure. As represented in FIG. 1 the preferred embodiment of the present invention is implemented through a network of at least five Nodes. The practical implementation of the preferred embodiment begins with the guest at Node-I accessing the website of the Hotel Group from either her office or home 10 for reserving a Hotel room in the city of her travel destination. The guest provides her personal and billing information including her mobile phone number, which information is stored in the Hotel Group's Master Web Server at Node-II. The Node-II hosts a database of all of the Hotel Group's property locations and guest information. The Node-II server receives the guest's online reservation 12 information and delivers it to the specific Node-III Communicator Server hosting the local area network (LAN) and the text-messaging server (TMS). Such information includes authorization 14 of guest's mobile phone as guest room key for the period of guest's stay in the specific destination hotel property served by the Node-III Communicator Server. The guest however has to activate the digital key by using her mobile phone (Node-IV) to remotely check in 16 the hotel when she arrives at the destination city airport. Such check in is easily effectuated by the mobile phone connecting to the hotel's Communicator Server by a simple click of a button using a standard text messaging or the SMS protocol. The Communicator Server identifies the guest mobile phone either by: a) its telephone number or b) by means of a digital watermark or c) firmware algorithm embedded on its subscriber identity module chip or d) the combination of either of the two or all the three combined. The Communicator Server then assigns a room to the guest depending upon the guest's preferences, and delivers a digital Room Access Code 18 to operate the room door lock and other gadgets within the room. The Communicator Server also writes the Room Access Code to the writable memory of the specific electronic lock securing the room assigned to the guest. When the guest arrives in the hotel building, she need not spend time at the front desk. Instead she can directly proceed to her assigned room and use her mobile phone by entering the assigned Room Access Code 20 in her mobile phone interface. Along with the mobile phone identification, the Room Access Code 20 is transmitted to the Node-II Communicator Server either by text messaging protocol, or by infrared link or by radiofrequency link or by Bluetooth link. The Communicator Server authenticates the mobile phone and presents the Room Access Code to the assigned guest room lock (Node-V) in the local area network. The writable memory of the electronic lock stores the Room Access Code, the identification of the guest mobile phone and the duration of stay until the time the room access code and the guest mobile phone remains valid. Thus, when the guest sends the room access code to the electronic lock through the Communicator Server, the Node-V electronic lock authenticates the code with the code stored in its writable memory. If the code and the mobile phone identification match, the electronic lock mechanism operates and releases the lock to allow the guest access to the room 24.

The room access code and the mobile phone ID are valid until the time the guest checks out. Once the guest checks out using her mobile phone the writable memory of the lock erases the access code and the guest mobile phone ID. The logs 26 of all guest activity are delivered to the Node-II Master Web Server, which uses the data to bill and charge the guest credit card account the money due for services rendered.

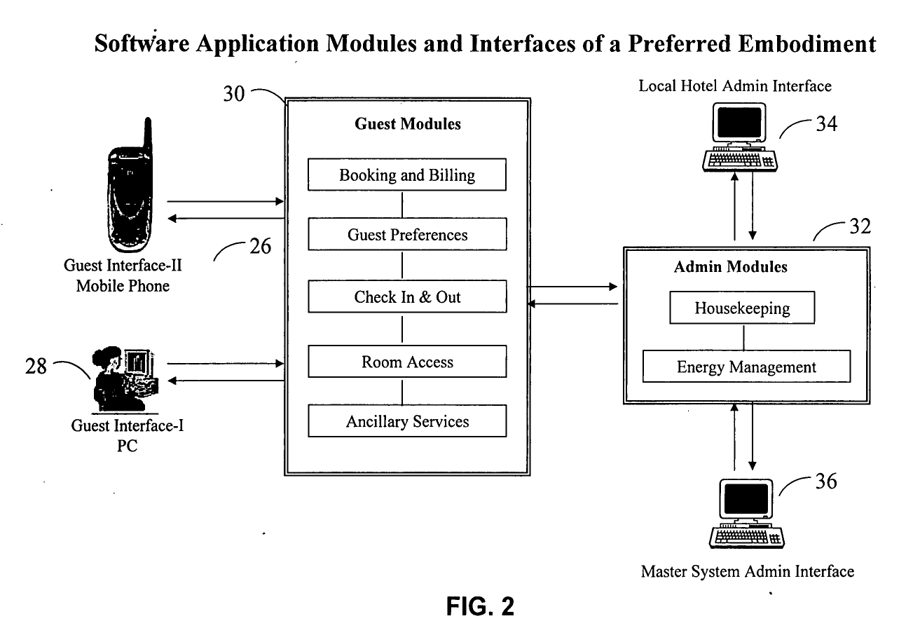

The complete implementation of the various features of the instant invention is enabled via a minimum of four interfaces as illustrated in FIG. 2. The method begins with the guest using her personal computer as Guest Interface-I 28 to connect to the Hotel's Master Web Server hosting an integrated software application comprising of at least five guest modules 30 and at a minimum two administration modules 32. The guest preferences module in concert with the housekeeping and energy management modules get the assigned guest room ready to guest's preferences. The guest can have only authorized interactions with the guest modules using either Guest Interface-I or Guest Interface-II, while the administration modules and the guest modules can be accessed by the Hotel management either using the Local Hotel Admin Interface 34 or Master Hotel Admin Interface 36. The seamless integration of the guest interfaces and modules with the administration interfaces and modules utilize the facilities resources efficiently thereby saving significant operational costs for the management. All the modules work in concert to provide value added services and convenience to the guests on the one hand, and improve the efficiency and economy of the Hotel for the owners of the Hotel facility on the other.

Although the above implementations refer primarily to cellular communication between the mobile phone and the electronic lock network, other types of wireless communication, e.g., WiFi, RF, Bluetooth, Infrared, etc., may be used. Although the above implementations refer to a hotel infrastructure, the principles apply equally to any other lock secured space, area or premises.

The present invention has been shown in the described embodiments for illustrative purposes only. Further, the terms and expressions which have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims which follow.

What I claim as my invention is:

1. An all-inclusive key and hospitality management system for controlling access to a lock-secured area, space or premises without the use of any physical key, card or any other type of physical contact, comprising of a computer-controlled electronic door lock connected to a private network of plurality of such electronic door locks, such private network providing limited network access to an authorized wireless device, which device can be used to remotely authenticate a time bound authorization of digital key to operate the designated electronic door and integrate access mechanism with software and hardware modules managing customer services, billing, housekeeping, energy efficiency and guest room ambience.

2. The system of claim 1, wherein the wireless communication link is a cellular phone network.

3. The system of claim 1, wherein the wireless communications link is a WiFi network.

4. The system of claim 1, wherein the wireless communications link is an infrared link.

5. The system of claim 1, wherein the wireless communications link is an RF link.

6. The system of claim 1, wherein the wireless communications link is a Bluetooth link.

7. The system of claim 1 wherein the wireless device is registered with and identified by the central controller by means of a digital watermark or firmware algorithm embedded on its subscriber identity module chip.

8. The system of claim 1 wherein the wireless device is a mobile phone registered with and identified by the central controller by its telephone number.

9. The system of claim 1 wherein the lock-secured premise is a room or a suite in a hotel or condominium.

10. The system of claim 1 wherein the lock-secured space is a storage locker.

11. The system of claim 1 wherein the digital key is generated and delivered to the wireless device of the user of the secured premises by contacting the remote server controlling the plurality of the electronic locks and the facilities administration modules.

12. The system of claim 1 wherein the digital key is terminated by the user of the premises when he checks out after a pre-defined period of time by means of the wireless communication with the remote server.

13. An all-inclusive key and integrated hospitality management system for reserving, availing, accessing, administering and managing a plurality of lock-secured areas or premises implemented through the following nodes:
a. Node-I, a guest personal computer;
b. Node-II, a remote Master Server;
c. Node-III, a remote Communicator Server;
d. Node-IV, a wireless communication device;
e. Node-V, a plurality of electronic locks; and
f. Node-VI, a plurality of guestroom paraphernalia.

14. A method of claim 13, wherein the lock-secured facility is administered and managed by the facility administrators by means of plurality of interlinked software application modules located at Nodes-II and III, comprising of at least five guest modules and at least two administrator modules.

15. A method of claim 13, wherein the lock-secured facility is reserved, availed and securely accessed by the user/guest/tenant by means of at least two interfaces, the first being the user's personal computer at Node 1, and the second being the user's wireless device at Node-IV.

16. A method of claim 13, wherein the lock-secured facility guest and administration modules are accessed by the facilities administrators through either a master system administration interface or a local system administration interface.

17. The system of claim 1, wherein the wireless communication link is a cellular phone network, and the wireless device is a mobile phone verified by the Node III Communicator Server by its assigned telephone number and by means of a digital watermark or firmware algorithm embedded on its subscriber identity module chip.

18. The system of claim 1, wherein the wireless communications link is a WiFi network.

19. The system of claim 13, wherein the wireless communications link is an infrared link.

20. The system of claim 13, wherein the wireless communications link is an RF link.

21. The system of claim 13, wherein the wireless communications link is a Bluetooth link.

22. The method of claim 13 wherein the digital key is generated and delivered to the wireless device of the user of the secured premises by contacting the remote server controlling the plurality of the electronic locks and the facilities administration modules.

23. The method of claim 13 wherein the digital key is terminated by the user of the premises when he checks out after a pre-defined period of time by means of the wireless communication with the Communicator Server.

24. A method of claim 13, wherein the Communicator Server of Node-III hosts local area network server and the text messaging server.

25. A method of claim 13, wherein the wireless device communicates with Node-III Communicator Server using the text messaging protocol to communicate with the Node V electronic locks.

26. A method of claim 13, wherein the wireless device communicates with Node-III Communicator Server using voice recognition protocol to communicate with the Node V electronic locks.

27. A method of claim 13, wherein the electronic lock of Node-V receives its digital access code for its operation from the authorized Node-IV wireless device via the Communicator Server.

28. A method of claim 13, wherein the guestroom paraphernalia including guestroom light fixture, thermostat, television, refrigerator, safe are controlled and modulated by guest preferences stored at Node III Communicator Server.
